(19) United States
(12) Patent Application Publication
(10) Pub. No.: US 2009/0046801 A1
(43) Pub. Date: Feb. 19, 2009

(54) METHOD AND APPARATUS FOR CREATING A MULTI-USER MIMO CODEBOOK USING A SINGLE USER MIMO CODEBOOK

(75) Inventors: Kyle Jung-Lin Pan, Smithtown, NY (US); Erdem Bala, Farmingdale, NY (US); Yingxue Li, Exton, PA (US); Donald M. Grieco, Manhasset, NY (US); Robert L. Olesen, Huntington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/190,296

(22) Filed: Aug. 12, 2008

Related U.S. Application Data
(60) Provisional application No. 60/955,741, filed on Aug. 14, 2007.
(60) Provisional application No. 60/955,778, filed on Aug. 14, 2007.

(51) Int. Cl. H04L 27/28

(52) U.S. Cl. 375/267

(57) ABSTRACT

A wireless communication method and apparatus for creating a codebook in a multiple input/multiple output (MIMO) wireless communication system are disclosed. The method includes adapting a single user codebook, wherein the single user codebook comprises a plurality single user beamforming vectors, into a multi-user codebook, wherein the multi-user codebook comprises a plurality of multi-user beamforming vectors. The method further includes grouping the codebook into a plurality of unitary matrices, selecting a plurality of beamforming vectors from the plurality of unitary matrices, forming a rank specific code-book from the beamforming vectors and the unitary matrices, and selecting a subset of a total number of pairs to form the plurality of unitary matrices.

### CROSS REFERENCE TO RELATED APPLICATIONS

This application claims the benefit of U.S. Provisional Application No. 60/955,741 filed Aug. 14, 2007 and U.S. Provisional Application No. 60/955,778 filed Aug. 14, 2007, which are incorporated by reference as if fully set forth.

### FIELD OF INVENTION

This application is related to wireless communications.

### BACKGROUND

Third generation partnership project (3GPP) Release 7 introduces multiple-input multiple-output (MIMO) for both high speed downlink packet access (HSDPA) single stream and dual streams operations in a wireless communication system 100 including at least one base station 105 and a plurality of wireless transmit/receive units (WTRUs) 110₁, 110₂ and 110₃. In single stream operations, a single transport block is transmitted by two or more antenna elements of a MIMO antenna of the base station 105. In dual or multiple stream operations, two transport blocks are transmitted simultaneously by the two or more antenna elements of the MIMO antenna of the base station 105. For both cases, linear weighting is applied at each antenna element of a MIMO antenna of each WTRU 110, and a preceding weight vector is selected from a finite set, based on a closed-loop mechanism where a receiver in the WTRU 110 signals the preferred preceding weight vector back to the base station 105. In 3GPP Release 8, this is accomplished as part of the preceding matrix feedback. When using dual stream operations, the downlink peak data rate for MIMO capable terminals is essentially doubled.

A method that uses rank-specific codebooks for multi-user MIMO (MU-MIMO) has the advantage of enabling efficient signaling and reduced signaling overhead. The method improves performance when interfering beamforming vectors are known, and enhances CQI computation and its accuracy of computation.

FIG. 2 shows a conventional single user MIMO (SU-MIMO) codebook of rank 1. In FIG. 2, the first column denotes the codebook index and the second column denotes the unit vector (uᵢ), which is used to construct a Householder matrix Wᵢ as follows:

$${W}_{i} = I - \frac{2 {u}_{i} {u}_{i}^{II}}{{u}_{i}^{H} {u}_{i}} ; \qquad Equation ( 1 )$$

where I is the identity matrix. The third column (Wᵢ^{{j}}) denotes the j^{th} column of the Householder matrix constructed using the i^{th} unit vector uᵢ.

Multi-user MIMO networks introduce the spatial sharing of the channel by the users. In spatial multiple access, the resulting multi-user interference is handled by the multiple antennas which, in addition to providing per-link diversity, also give the degrees of freedom necessary for spatial separation of the users.

### SUMMARY

A method for creating a codebook in a MIMO wireless communication environment is disclosed. The method may include adapting an SU codebook that includes a plurality of SU preceding matrices, into an MU codebook that includes a plurality of MU beamforming vectors. The method may also include grouping the codebook into a plurality of unitary matrices, selecting a plurality of beamforming vectors from the plurality of unitary matrices, forming a rank specific code-book from the beamforming vectors and the unitary matrices, and selecting a subset of a total number of pairs to form the plurality of unitary matrices.

A MU-MIMO scheme may be used for 3GPP Long Term Evolution (LTE) systems using the codebook design and control signaling methods disclosed herein.

### BRIEF DESCRIPTION OF THE DRAWINGS

A more detailed understanding may be had from the following description, given by way of example in conjunction with the accompanying drawings wherein:

FIG. 1 shows a conventional wireless communication system including a base station and a plurality of WTRUs;

FIG. 2 shows a conventional SU-MIMO codebook of rank 1;

FIGS. 3, 4A and 4B show beam shapes beamformed by different vectors;

FIG. 5 shows a predefined table for different combinations of beamforming vectors;

FIGS. 6-8 show examples of codebooks;

FIGS. 9-11 show methods for reusing an SU-MIMO codebook to create an MU-MIMO codebook;

FIG. 12 is a block diagram of a WTRU configured to use the MU-MIMO codebook created using the methods of FIGS. 9-11; and

FIG. 13 is a block diagram of a base station configured to use the MU-MIMO codebook created using the methods of FIGS. 9-11.

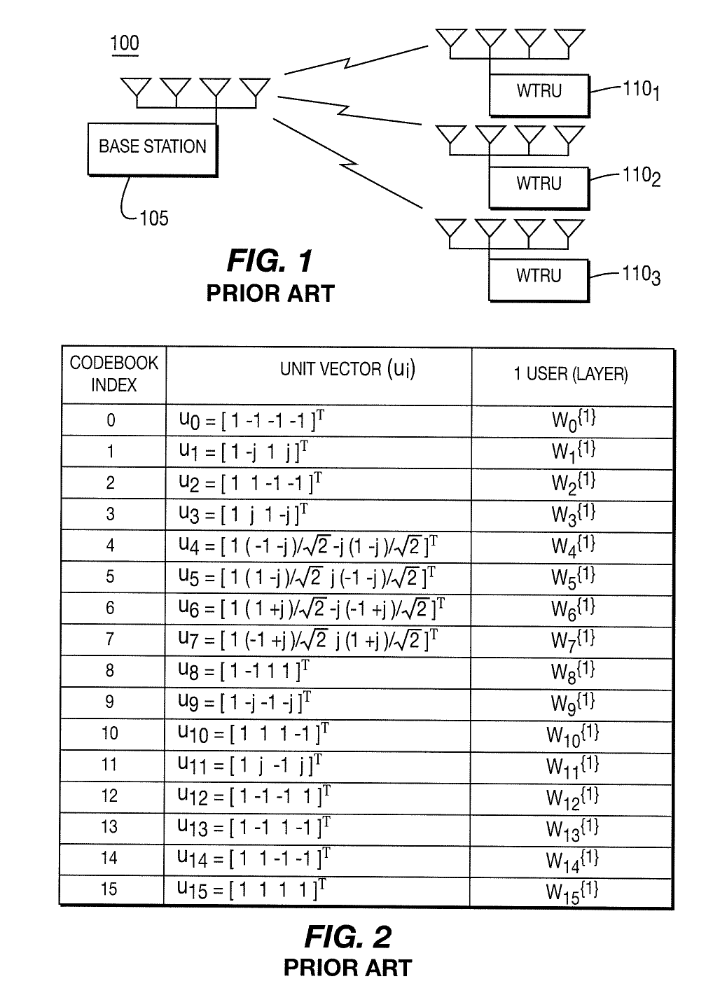

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

When referred to hereafter, the terminology “base station” includes but is not limited to a Node-B, eNode-B, a site controller, an access point (AP), or any other type of interfacing device capable of operating in a wireless environment.

The method includes the reuse of SU-MIMO codebooks for MU-MIMO. Initially, a full codebook of rank 1 is selected. A subset of the codebook may also be selected. Next, the codebook or selected subset is grouped into one or more unitary matrices. At the next step, pairs of beamforming vectors are selected from unitary matrices. Lastly, the rank-specific codebook is formed for MU-MIMO.

A codebook that can be used for MU-MIMO is referred to as a rank-1 SU-MIMO codebook. In MU-MIMO, each WTRU gets one data stream and up to four WTRUs can be scheduled for simultaneous transmission when a base station has four antennas. The SU-MIMO rank-1 codebook for 4×4 antenna configuration consists of sixteen beamforming vectors, where each vector is of size 4×1, assuming that the base station has four transmit antennas. These sixteen vectors can be grouped into four matrices, where each matrix consists of four orthogonal vectors, i.e., the matrices are unitary. If the vectors have indices 1-16, then the matrices consist of the following vectors: Matrix1={1,2,3,4}, Matrix2={5,6,7,8}, Matrix3={9,10,11,12}, and Matrix4={13,14,15,16}. Grouping is done such that the resulting groups or matrices, Matrix1, Matrix2, Matrix3 and Matrix4 are unitary matrices.

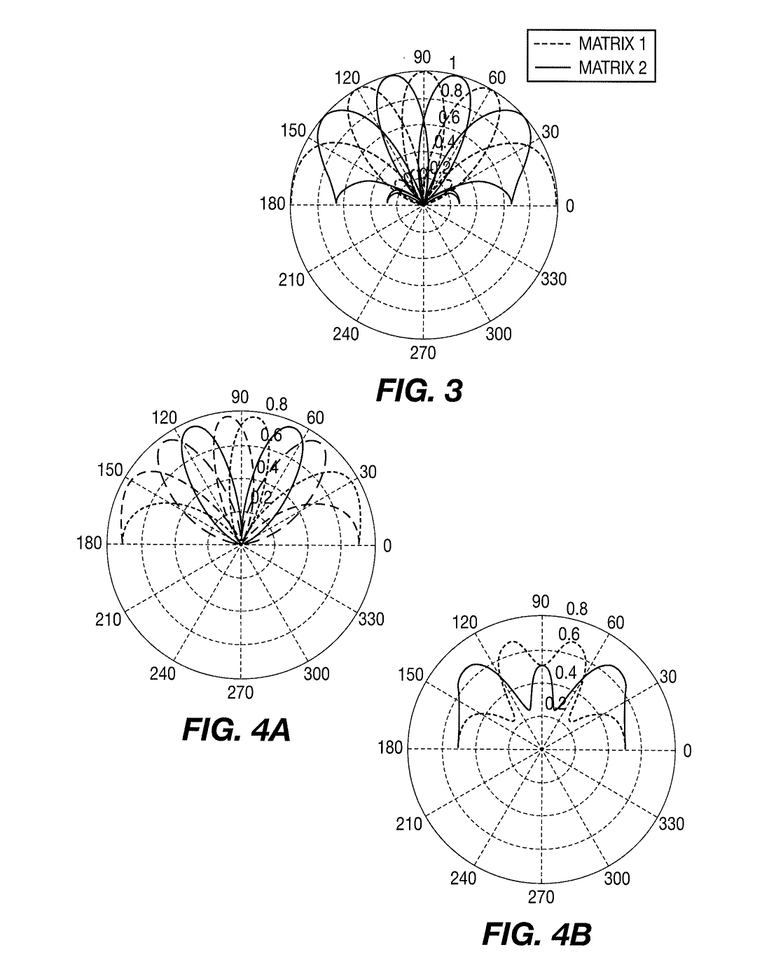

FIGS. 3, 4A and 4B illustrate exemplary beam patterns for the sixteen vectors. FIG. 3 shows the beam patterns generated using the vectors in Matrix 1 and Matrix 2. FIG. 4A shows the beam patterns generated using the vectors in Matrix 3. FIG. 4B shows the beam patterns generated using the vectors in Matrix 4. Although these beam patterns are for a line of sight channel, it can be seen that the first eight vectors have shaped beams.

One method of using MU-MIMO is spatial division multiplexing (SDMA), where the transmitter antennas are closely spaced, for example with distance 0.5λ, and beams are formed. Each beam serves a different WTRU. The first 8 vectors from the SU-MIMO codebook, i.e., Matrix 1 and Matrix 2, may be used as the codebook for MU-MIMO.

Using a codebook, the base station selects multiple WTRUs that will receive simultaneous transmission on the same frequency and time resources. The data of each WTRU is precoded by using a beamforming vector from the codebook. The precoding vectors for different WTRUs can be selected using a unitary approach or a non-unitary approach. For the unitary approach, the base station uses orthogonal vectors for different WTRUs, i.e., the vectors are selected from columns of the same unitary matrix. For the non-unitary approach, the base station can use any two vectors regardless of their correlation, i.e., vectors from different matrices can be used. Unitary preceding results in reduced inter-user interference and is therefore preferable over the non-unitary approach. However non-unitary approach has more flexibility than unitary approach.

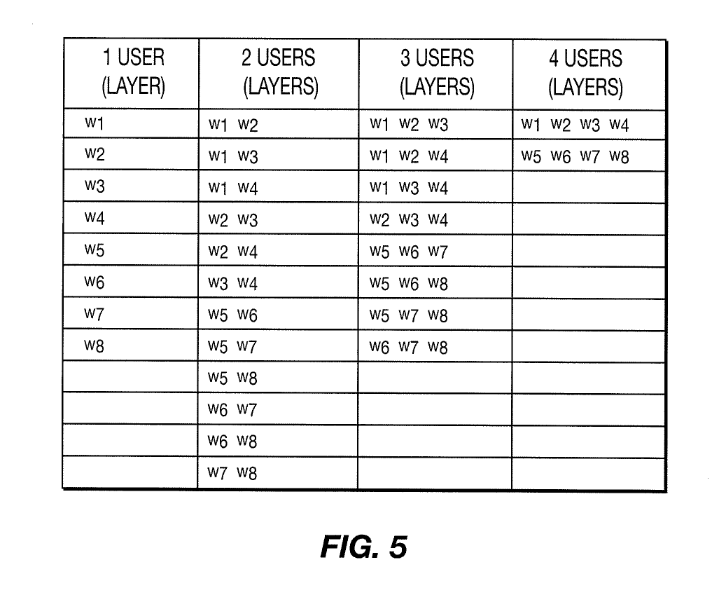

A downlink control signaling structure that does not require any change in the SU-MIMO signaling structure is proposed, where it is assumed that the codebook is size 8, i.e., Matrix1 and Matrix2 are used as the codebook. Note that any two matrices from the SU-MIMO codebook may also be used if they are indicated, e.g., by the higher layers. If the codebook consists of eight vectors, the possible combinations of vectors used for different numbers of WTRUs are shown in a predefined Table, as shown in FIG. 5.

In FIG. 5, vectors w₁-w₄ belong to one matrix and vectors w₅-w₈ belong to a different matrix. The number of users indicates the maximum number of WTRUs scheduled for simultaneous transmission. Each combination is given a number. For example, with two WTRUs, there are twelve possible combinations, and these combinations are indexed from 1 to 12. For twelve possible combinations, four bits are needed for signaling one of these combinations. For higher numbers of WTRUs, such as three or four WTRUs, fewer than four bits are needed.

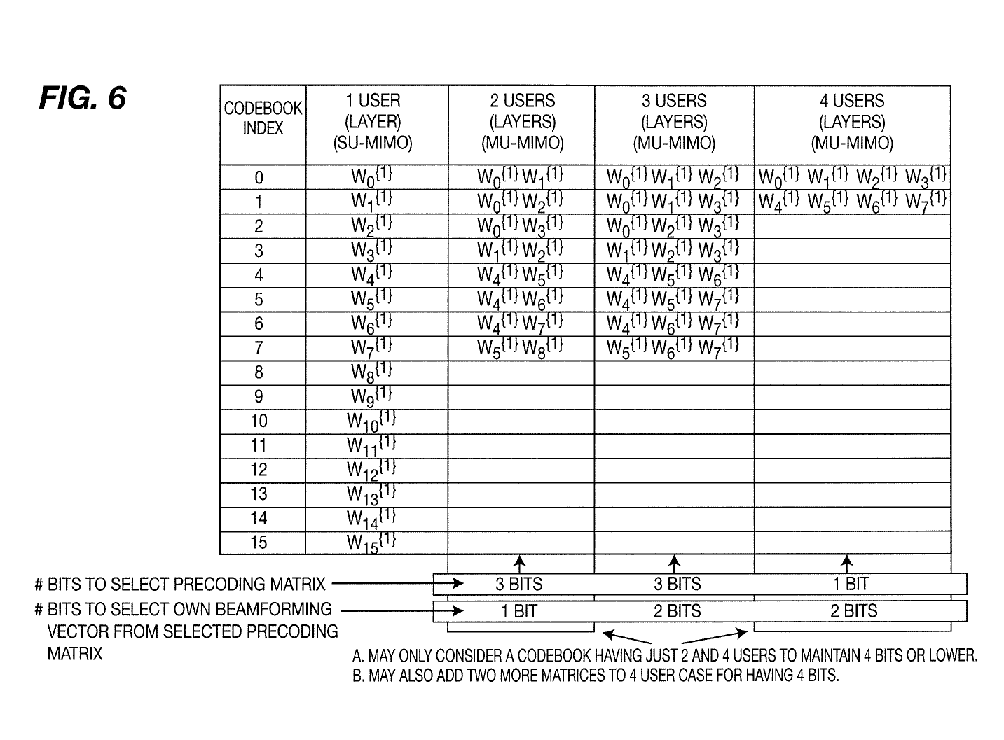

FIG. 6 shows an example of a codebook for MU-MIMO that simultaneously supports up to four WTRUs. The first column denotes the codebook index. The second column denotes the beamforming vector generated from a Householder matrix for one WTRU, (i.e., user, layer). The third column denotes the beamforming vectors for two WTRUs. The forth column denotes the beamforming vectors for three WTRUs. The last column is the beamforming vectors for four WTRUs. There are eight beamforming vectors combinations for two WTRUs, eight beamforming vectors combinations for three WTRUs, and two beamforming vectors combinations for four WTRUs. Three bits can be used to indicate which beamforming vector combination is used for two or three WTRUs, and one bit can be used to indicate which beamforming vector combination is used with four WTRUs. In addition, one or two bits can be used to indicate the own beamforming vector for a particular WTRU within the beamforming vector combination being indicated. The beamforming vectors combinations are selected such that the performance is optimized and overhead is minimized.

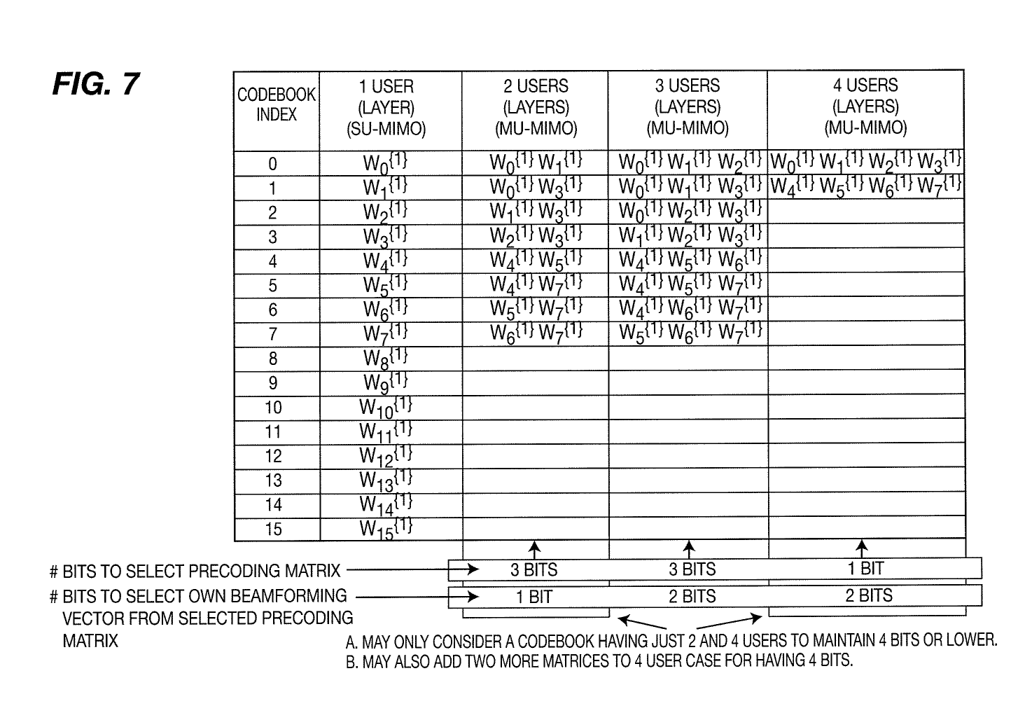

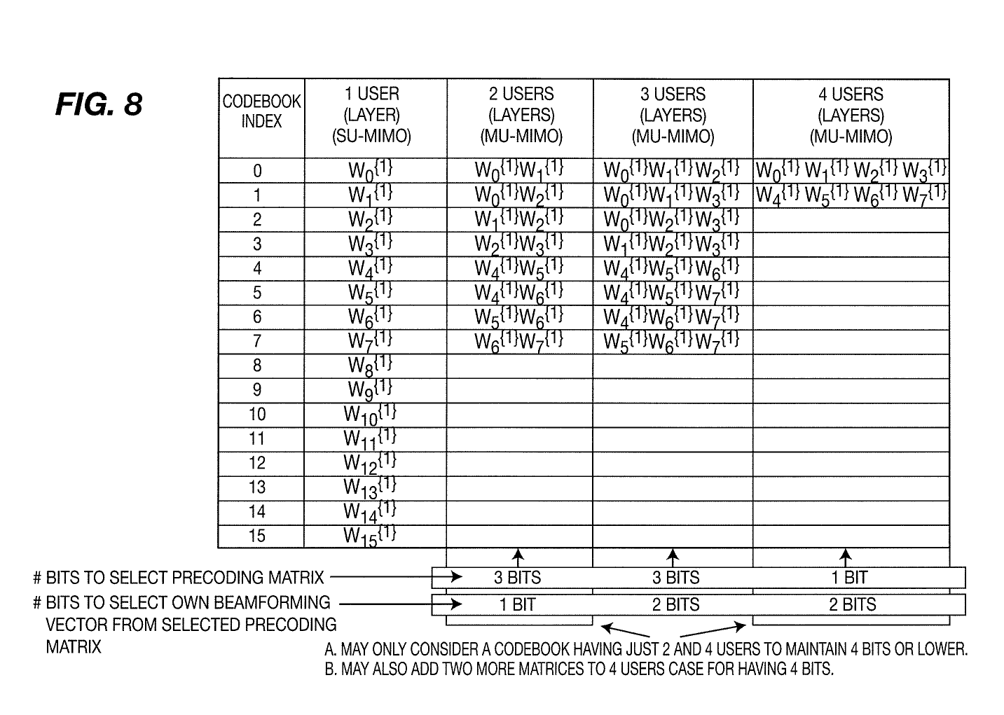

FIGS. 7 and 8 shows examples of a codebook for MU-MIMO supporting up to four WTRUs simultaneously with slightly different beamforming vector combinations but with the same signaling overhead.

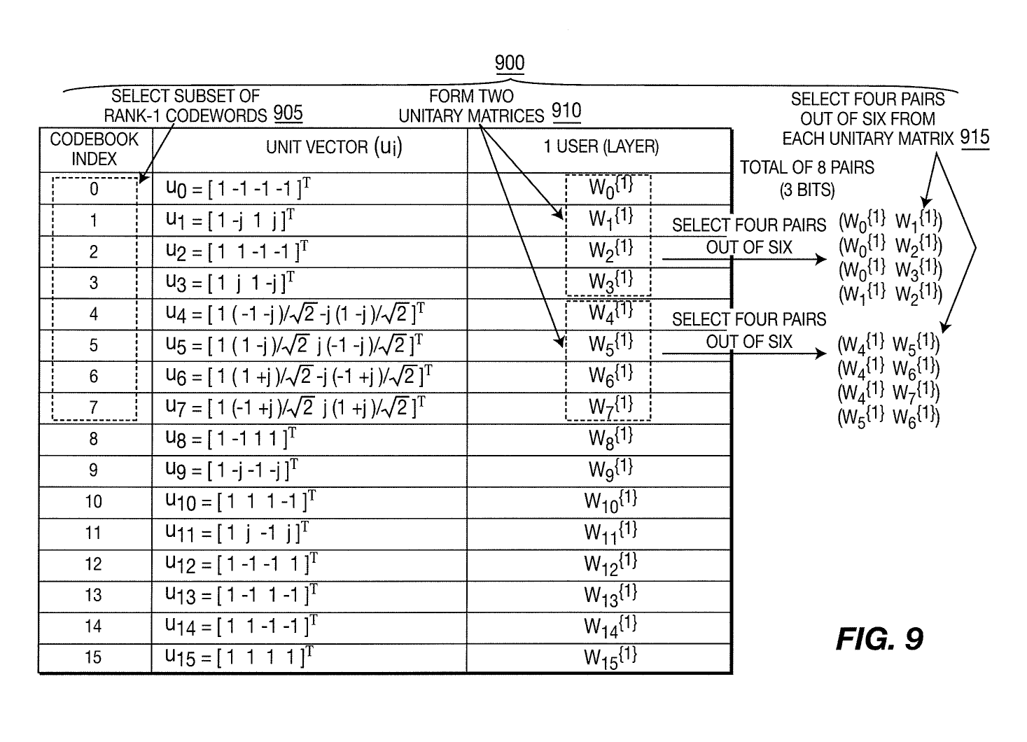

FIG. 9 shows an example of a procedure 900 for generating a codebook for MU-MIMO using a SU-MIMO codebook. After a SU-MIMO codebook is chosen, a subset of rank-1 (single user) precoding vectors is selected. For example, in the example shown in FIG. 9, codebook indices 0-7 out of indices 0-15 are selected (step 905). Then, a first group of beamforming vectors W₀^{{1}}-W₃^{{1}} associated with codebook indices 0-3 are used to form a first unitary matrix and a second group of beamforming vectors W₄^{{1}}-W₇^{{1}} associated with codebook indices 4-7 are used to form a second unitary matrix (step 910). Finally, pairs of the beamforming vectors are selected to form the codebook (step 915). For example, four pairs of the beamforming vectors are selected out of six possible pairs in each of the unitary matrices to form codebooks for two WTRUs as shown in FIG. 9.

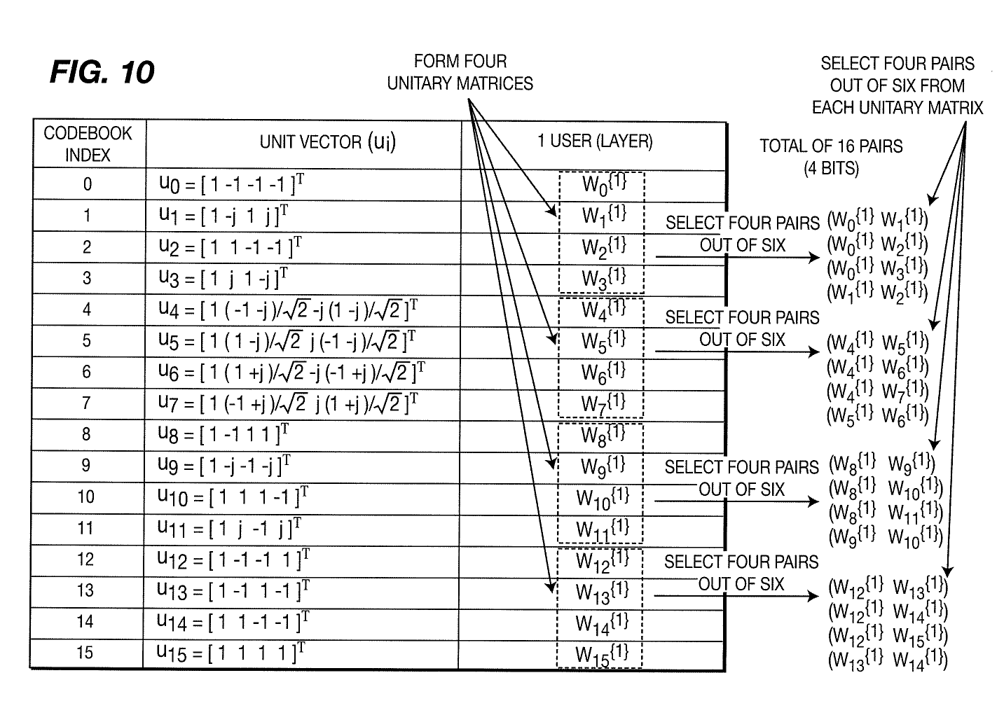

FIG. 10 shows another example of generating a codebook for MU-MIMO using a SU-MIMO codebook. In this example, of the beamforming vectors associated with the codebook indices 0-15 are grouped into four groups, each having four of the beamforming vectors.

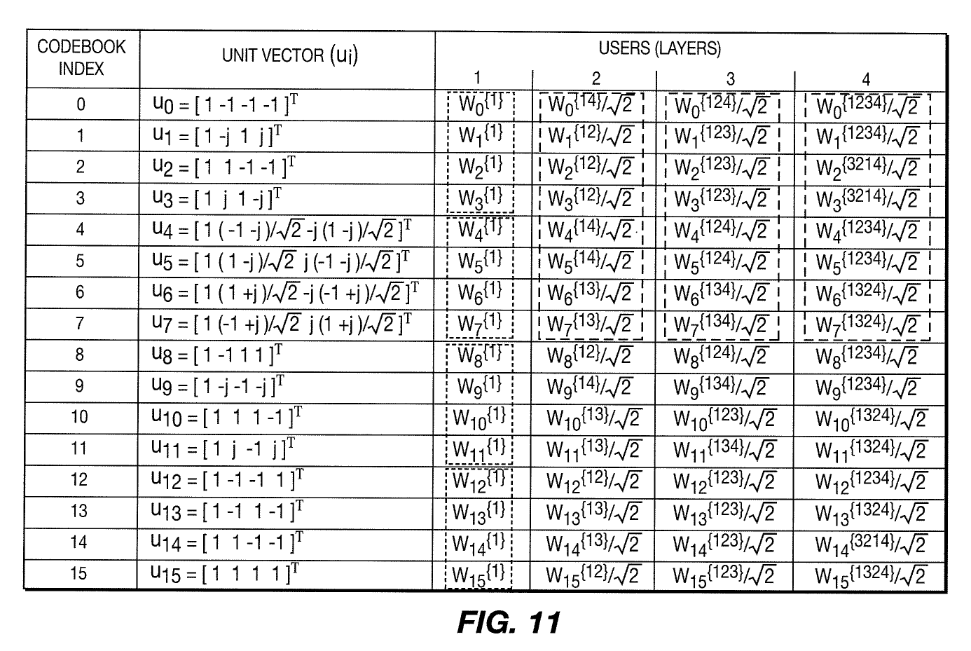

FIG. 11 shows yet another example of generating a codebook for MU-MIMO using a SU-MIMO codebook. The matrix Wᵢ^{{i,k}} denotes the j^{th} and k^{th} column of a Householder matrix generated using the i^{th} unit vector, which are used as a codebook for two WTRUs. The matrix Wᵢ^{{i,k,l}} denotes the j^{th}, k^{th} and l^{th} column of a Householder matrix generated using the i^{th} unit vector, and are used as a codebook for three WTRUS. The matrix Wᵢ^{{i,k,l,m}} denotes the j^{th}, k^{th}, l^{th} and m^{th} column of a Householder matrix generated using the i^{th} unit vector, and are used as codebook for four WTRUS. The number of columns used depends on the number of WTRUS, or depends on the number of transmission layers if a WTRU is assigned by more than one transmission layer.

If the base station uses the unitary approach, the index of the combination from the table in FIG. 5 is found and signaled by the base station using four bits. An additional bit is also sent to indicate that the vector selected by the WTRU is not overriden by the base station. If the base station prefers to use another vector other than the one selected by the WTRU, and uses a non-unitary approach, it transmits the index of that vector. The additional bit is then set to indicate the eNodeB overriding.

If the base station prefers to use another vector other than the one selected by the WTRU, and the base station uses the unitary approach, it transmits the index of that vector. The additional bit is then set to indicate that the vector selected by the WTRU is overriden by the base station.

It is proposed to use the first eight (8) vectors from the SU-MIMO codebook as the MU-MIMO codebook. It is possible to use any eight vectors from the codebook if they are signaled by higher layer signaling. It is further proposed to use a unitary approach, although the base station is free to choose any precoding vectors for the WTRUS. The proposed control structure does not introduce any overhead over the SU-MIMO structure and can be used with the proposed structure.

A channel response matrix H can be decomposed into three matrices U, D and V using singular value decomposition (SVD) as:

Hᵢ=UᵢDᵢVᵢ^{H}. Equation (2)

Let dᵢ^{q} be the largest singular value of Hᵢ, V_{i,D} be the dominant column vector of Vᵢ and V_{i,Q} be quantized V_{i,D} using a codebook.

Two feedback CQIs are defined: a basic CQI which is identical to the definition in SU-MIMO, and a supplemental CQI, which captures the interference caused by other WTRUs. It can be seen later, due to unitary precoding, that the interference is fully decided by feedback quantization error. Thus, the interference is determined by the codebook used. The codebook is used to quantize the dominant beamforming vector obtained from SVD into a beamforming vector defined in the codebook.

The basic and supplemental CQIs are computed as follows:

$${CQI}_{WTRU , basic , i} = \frac{{d}_{i 1}^{2} {ρ}_{i}^{2} {E}_{s}}{{σ}_{n , i}^{2}} , where \\ {ρ}_{i} = \vert {V}_{i , Q}^{H} {V}_{i , D} \vert ; \qquad Equation ( 3 )$$

where Es is the symbol power and σ_{n,i}² is the noise power, and

$${CQI}_{WTRU , sup , i} = \frac{{ρ}_{i}^{2}}{{‖ {V}_{i , D} - {V}_{i , Q} ‖}^{2}} = \frac{{ρ}_{i}^{2}}{{Δ}_{i}^{2}} . \qquad Equation ( 4 )$$

The error vector eᵢ is defined as the difference between the dominant beamforming vector V_{i,Q} and its quantized version V_{i,D}

eᵢ=V_{i,Q}−V_{i,D}. Equation (5)

The interference Zᵢ can be expressed by:

Zᵢ=HᵢV_{k,Q}\sqrt{Es}=(V_{i,Q}^{H}+eᵢ^{H})V_{k,Q}d_{i,1}\sqrt{E_{S}}=d_{i,l}eᵢ^{H}V_{k,Q}\sqrt{Eₛ}. Equation (6)

The interference is upper bounded by

$${\vert {Z}_{i} \vert}^{2} \leq {d}_{i 1}^{2} {‖ {e}_{i}^{H} ‖}^{2} {E}_{s} = {d}_{i , 1}^{2} {Δ}_{i}^{2} {E}_{s} = \frac{{d}_{i}^{2} {ρ}_{i}^{2} {E}_{s}}{{CQI}_{WTRU , sup , i}} . \qquad Equation ( 7 )$$

That is, the interference is not larger than a certain value as shown in Equation (7). Therefore, the signal-to-interference plus noise ratio (SINR) from the base station perspective can therefore be lower bounded by:

$${CQI}_{NB , i} \geq \frac{1}{\frac{1}{{CQI}_{WTRU , , basic , i}} + \frac{1}{{CQI}_{WTRU , sup , i}}} . \qquad Equation ( 8 )$$

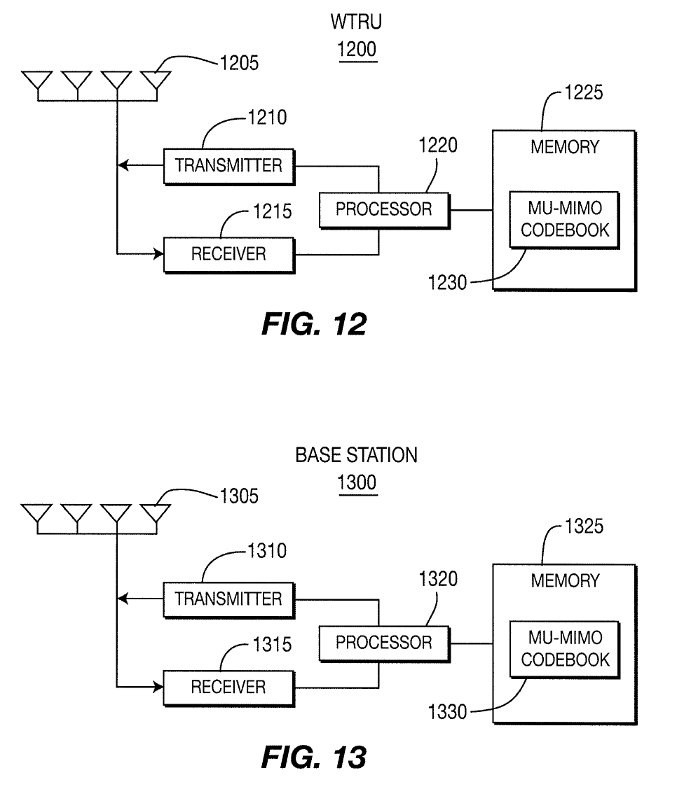

FIG. 12 is a block diagram of a WTRU 1200 comprising a MIMO antenna 1205, a transmitter 1210, a receiver 1215, a processor 1220 and a memory 1225. The memory 1225 includes a MU-MIMO codebook 1230 stored therein.

The receiver 1215 in the WTRU 1200 receives a control signal and obtains the beamforming information, (e.g., codebook index). The processor 1220 translates a beamforming vectors index or a codebook index into the beamforming vectors from the MU-MIMO codebook 1230 stored in the memory 1225 based on the beamforming information, and processes data using the determined beamforming vectors. Each WTRU 1200 selects one of a plurality of beamforming vectors and feeds back the index by using a predetermined number of bits, as well as both basic and supplemental CQIs.

The processor 1220 in the WTRU 1200 computes the basic and supplemental CQIs, which are then transmitted by the transmitter 1210 via the MIMO antenna 1205. The receiver 1215 may receive rules for creating the MU-MIMO codebook 1230 from a SU-MIMO codebook from a base station via higher signaling. The set of rules are defined and known to both base station and the WTRU 1200. Once the WTRU 1200 receives the rules that are indicated by base station, the processor 1220 can create the MU-MIMO codebook 1230 in real time such that there is no need for storing the MU-MIMO codebook in physical memory. Only an SU-MIMO codebook is needed. Which portion and partition of the SU-MIMO codebook and how to use it is defined by the rules that are indicated by the base station.

FIG. 13 is a block diagram of a base station 1300 comprising a MIMO antenna 1305, a transmitter 1310, a receiver 1315, a processor 1320 and a memory 1325. The memory 1325 includes a MU-MIMO codebook 1330 stored therein. The base station 1300 schedules a plurality of WTRUs 1200 for MU-MIMO transmission. The receiver 1315 in the base station 1300 receives a beamforming or preceding feedback signal from at least one WTRU 1200 and obtains the beamforming information, (e.g., codebook index). The processor 1320 translates a beamforming vectors index or a codebook index into the beamforming vectors from the MU-MIMO codebook 1330 stored in the memory 1325 based on the beamforming information received, and processes data using the determined beamforming vectors. The processor 1320 also processes a CQI feedback signal sent by the WTRU 1200, and combines the CQI feedback (basic and supplemental CQIs) to create a final CQI to be used to determine a proper modulation and coding scheme for data transmission at the base station 1300 for MU-MIMO.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of generating a codebook for multi-user multiple-input multiple-output (MU-MIMO) communications, the method comprising:
forming a plurality of unitary matrices based on a single user MIMO (SU-MIMO) codebook, each unitary matrix including a subset of beamforming vectors included in the SU-MIMO codebook; and
selecting pairs of the beamforming vectors from each of the unitary matrices to form a MU-MIMO codebook.

2. The method of claim 1 wherein the SU-MIMO codebook includes sixteen beamforming vectors, and each unitary matrix includes four of the sixteen beamforming vectors.

3. The method of claim 2 wherein four pairs of the beamforming vectors are selected from each of the unitary matrices.

4. The method of claim 1 wherein four unitary matrices are formed, each unitary matrix having four orthogonal beamforming vectors.

5. The method of claim 1 further comprising:
selecting a plurality of wireless transmit/receive units (WTRUS) that will receive simultaneous transmission on the same frequency and time resources; and
preceding data for each WTRU using orthogonal vectors, wherein the vectors are selected from columns of the same unitary matrix.

6. The method of claim 1 further comprising:
selecting a plurality of wireless transmit/receive units (WTRUs) that will receive simultaneous transmission on the same frequency and time resources; and
preceding data for each WTRU using vectors from different matrices.

7. The method of claim 1 further comprising:
using a predetermined number of bits to indicate which beamforming vector combinations are to be used, wherein the number of bits is based on a number of wireless transmit/receive units (WTRUs) that are supported by the MU-MIMO codebook.

8. A wireless transmit/receive unit (WTRU) comprising:
a multiple-input multiple-output (MIMO) antenna;
a receiver coupled to the MIMO antenna, the receiver configured to receive a plurality of beamforming vectors via the antenna;
a transmitter coupled to the MIMO antenna, the transmitter configured to transmit feedback information;
a processor coupled to the receiver and the transmitter; and
a memory coupled to the processor, the memory configured to store at least one multi-user MIMO (MU-MIMO) codebook, wherein the MU-MIMO codebook is created by forming a plurality of unitary matrices based on a single user MIMO (SU-MIMO) codebook, each unitary matrix including a subset of beamforming vectors included in the SU-MIMO codebook, and selecting pairs of the beamforming vectors from each of the unitary matrices to form the MU-MIMO codebook.

9. The WTRU of claim 8 wherein the SU-MIMO codebook includes sixteen beamforming vectors, and each unitary matrix includes four of the sixteen beamforming vectors.

10. The WTRU of claim 9 wherein four pairs of the beamforming vectors are selected from each of the unitary matrices.

11. The WTRU of claim 8 wherein four unitary matrices are formed, each unitary matrix having four orthogonal beamforming vectors.

12. The WTRU of claim 8 wherein a predetermined number of bits are used to indicate which beamforming vector combinations are to be used, wherein the number of bits is based on a number of WTRUs that are supported by the MU-MIMO codebook.

13. A wireless transmit/receive unit (WTRU) comprising:
a multiple-input multiple-output (MIMO) antenna;
a processor configured to compute a basic channel quality indicator (CQI) and a supplemental CQI; and
a transmitter electrically coupled to the antenna and the processor, wherein the transmitter is configured to transmit the basic and supplemental CQIs via the antenna, the supplemental CQI being associated with interference caused by interfering wireless transmit/receive units (WTRUs).

14. The WTRU of claim 13 wherein the interference is determined based on a feedback quantization error.

15. A wireless transmit/receive unit (WTRU) comprising:
a multiple-input multiple-output (MIMO) antenna;
a receiver electrically coupled to the antenna, the receiver configured to receive a control signal having beamforming information via the antenna, the beamforming information including at least one of a beamforming vectors index or a codebook index;
a memory configured to store a multi-user MIMO (MU-MIMO) codebook; and
a processor electrically coupled to the receiver and the memory, the processor configured to translate a beamforming vectors index or a codebook index into beamforming vectors determined from the MU-MIMO codebook, and process data using the determined beamforming vectors.

16. The WTRU of claim 15 wherein the processor is further configured to select one of the determined beamforming vectors, the WTRU further comprising:
a transmitter configured to transmit a predetermined number of bits, a basic channel quality indicator (CQI) and a supplemental CQI.

17. A wireless transmit/receive unit (WTRU) comprising:
a multiple-input multiple-output (MIMO) antenna;
a receiver electrically coupled to the antenna, the receiver configured to receive rules for creating a multi-user MIMO (MU-MIMO) codebook from a single-user MIMO (SU-MIMO) codebook; and
a processor electrically coupled to the receiver, the processor configured to create the MU-MIMO codebook in real time such that there is no need for storing the MU-MIMO codebook in physical memory.

18. A base station comprising:
a multiple-input multiple-output (MIMO) antenna;
a receiver electrically coupled to the antenna, the receiver configured to receive beamforming information, a basic channel quality indicator (CQI) and a supplemental CQI, the supplemental CQI being associated with interference caused by interfering wireless transmit/receive units (WTRUs);
a memory configured to store a multi-user MIMO (MU-MIMO) codebook;
a processor electrically coupled to the memory and the receiver, the processor configured to translate a beamforming vectors index or a codebook index into the beamforming vectors determined from the MU-MIMO codebook, and processes data using the determined beamforming vectors; and
a transmitter configured to transmit rules for creating a MU-MIMO codebook from a single user MIMO (SU-MIMO) codebook.

19. The base station of claim 18 wherein the processor is further configured to combine the basic and supplemental CQIs to create a final CQI to be used to determine a proper modulation and coding scheme for data transmission for MU-MIMO.
